(19) United States
(12) Patent Application Publication
(10) Pub. No.: US 2026/0017915 A1
(43) Pub. Date: Jan. 15, 2026

(54) METHOD AND SYSTEM FOR IDENTIFYING EMBEDDED INFORMATION

(71) Applicant: Wiretronic AB, VÄNERSBORG (SE)

(72) Inventors: Christoffer WEBER, VÄNERSBORG (SE); Ludwig FRIBORG, GÖTEBORG (SE)

(73) Assignee: Wiretronic AB, VÄNERSBORG (SE)

(21) Appl. No.: 19/113,724

(22) PCT Filed: Oct. 2, 2023
(86) PCT No.: PCT/SE2023/050978

§ 371 Date: Mar. 20, 2025

(30) Foreign Application Priority Data
Oct. 7, 2022 (SE) 2251170-3

(51) Int. Cl. G06V 10/30; G06T 1/00; G06V 10/82; G06V 10/94; G06V 20/00

(52) U.S. Cl. CPC G06V 10/30; G06T 1/0028; G06V 10/82; G06V 10/94; G06T 2201/0065; G06V 20/95

(57) ABSTRACT

The present disclosure generally relates to a method adapted to identifying a predefined component embedded within image data of a target object. This is in line with the present disclosure achieved by applying a machine-learning based scheme that has been arranged to identify a noise component from an image illustrating the target object. The present disclosure also relates to a corresponding computer system and a computer program product.

### TECHNICAL FIELD

The present disclosure generally relates to a method adapted to identifying a predefined component embedded within image data of a target object. This is in line with the present disclosure achieved by applying a machine-learning based scheme that has been arranged to identify a noise component from an image illustrating the target object. The present disclosure also relates to a corresponding computer system and a computer program product.

### BACKGROUND

There has always been an ongoing problem with unauthorized parties making copies of physical objects, such as copyrighted paintings, photographs, and analog audio tapes, as well as bags, cloths, etc. Watermarking has been devised as a security technique to facilitate the separating an original from a copy. Different techniques have been developed throughout the years, but generally relies on embedding an identification code with the physical object.

Preferably, the identification code is imperceptible to the human observer, at least not disturbing the look-and-feel of the physical object. However, if the identification code is “too well hidden” then it may also be complicated to identify the code and thus the process of ensuring a validity of the physical object may be unreliable. On the other hand, in case the code is to obvious and easily identifiable, it may possibly be “too easy” to also copy the code successfully. A best balance is struck when a watermark amplitude is raised to just below the point where the watermark pattern becomes visible to human viewers of the packaging.

One solution to this problem is presented in US2020311505. US2020311505 specifically suggests forming a stylized version of a digital watermark signal, based on an input digital watermark signal image and one or more source images. The stylized version of the watermark signal is composed as a collage or mosaic from pixel patches excerpted from the target images. To a human observer, the stylized artwork is evocative of the source image(s), rather than the watermark signal. However, to a compliant digital watermark decoder the stylized artwork is interpreted as a signal carrier, conveying an encoded plural-symbol payload.

However, even though the solution presented in US2020311505 has a positive impact on watermarking, it still relies on distinct modifications that, with the right type of decoder can be identified and if necessary copied. Accordingly, there seems to be room for further improvements in relation to watermarking, further heightening the security surrounding the watermark and with the intention to making it even harder for unauthorized parties to identify the watermark.

### SUMMARY

According to an aspect of the present disclosure, it is therefore provided a method for identifying a predefined component embedded within image data of a target object, wherein the computer system comprises a processing unit and the method comprising the steps of receiving, at the processing unit, the image data, identifying, by the processing unit, a noise component from the image data by applying a machine-learning based scheme to the image data, wherein the noise component is embedded with the target object, deriving, by the processing unit and based on identifiable features comprised with the noise component, the predefined component from the identified noise component, and identifying, by the processing unit, the predefined component by comparison with prestored data in a memory element arranged in communication with the processing unit.

The present disclosure is based upon the realization that it can be possible to further heightening the security surrounding the watermark by arranging the watermark (above defined as a predefined embedded component) as a noise component that is embedded with the image of the target object and generally not visually perceived by the naked eye of a person looking at the target object. When the watermark is embedded as noise, it will not be visually perceived by the user as an alternation of the image of the target object, but rather just as a normal image. However, the previously presented prior-art decoder will at the same time not be able to identify relevant information from the image data, since the predefined component will be too well embedded.

This prior-art decoder problem is according to the present disclosure handled by applying a machine-learning based scheme to the image data. The machine-learning-based scheme has preferably been previously trained towards different related noise based predefined components, corresponding but not necessarily the same as the noise component embedded in the presently processed image data of the target object. Once trained, the machine-learning based scheme will be able to identify at least a specific type of noise component. This type of noise component may then be altered, within a predefined range, to form a large number of different identifiable noise components for use with target object.

The term “noise component” should be interpreted broadly within the scope of the present disclosure. For example, the noise component may comprise a predefined pattern possibly altered according to a predefined scheme, a predefined frequency component possibly altered within a predefined range, etc.

As defined in accordance with the present disclosure, a machine-learning based scheme is applied for correctly identifying the noise component from the image data. As indicated above, it may generally be desirable to ensure that the machine-learning based scheme has been “trained” in such a manner that the scheme swiftly can identify different noise components of a specific type, such as by training the machine-learning based scheme with a plurality of different image data each comprising a known noise component.

The training must however not necessarily be performed for each processing unit but may be performed in a general manner and in advance when developing the machine-learning based scheme. It should further be understood that the machine-learning based scheme may be implemented using one or a combination of different machine-learning algorithms, also including neural networks in deep learning, also including artificial neural networks (ANN), such as but not limited to convolutional neural networks (CNN), feed-forward neural networks (FNN), etc. It may also be possible to arrange the machine-learning based scheme to comprise a machine-learning pipeline, where the machine-learning pipeline in turn may be arranged to comprise a plurality of autoencoder components.

The step of deriving the predefined component from the identified noise component may in some embodiments comprise the process of identifying identifiable features from the identified noise component. The noise component may as such be seen as e.g. a “fingerprint”, where the process of deriving the predefined component from the identified noise component can be seen as a feature extraction process, where specific types of features are identified in the noise component. Other schemes for deriving the predefined component from the identified noise component are of course possible and within the scope of the present disclosure.

It should be understood that the steps of identifying the noise component and deriving the predefined component (from the identified noise component) in some embodiments may be performed as a single step by the processing unit.

When performing the step of identifying the predefined component by comparison with prestored data, it may generally be desirable to arrange the prestored data in some form of memory element, for example comprised with a database. As such, the processing unit may be arranged to perform the comparison by trying to find a best match (or candidates) between the predefined component and other components stored in the database. It may of course be possible to arrange the database remotely from where the computer system and/or processing unit is/are located, as such allowing the database to be shared between a large number of different processing units.

The present disclosure may be applied in different areas. As such, in some embodiments the scheme according to the present disclosure may be used for digital watermarking of for example an image, i.e. where the target object is defined as the image, preferably a digital image. Such an image may for example be an artistic photography, etc., where a preselected noise component is combined with the image to form a “noisy image”.

However, the scheme according to the present disclosure may be highly useful also in situations where the target object is a physical object. Such a physical object may be any form of physical object that is suitable for allowing inclusion of the predefined component, i.e. where the predefined component is somewhat embedded with the physical object.

It may thus, in accordance with the present disclosure be possible to further adapt the method to include the step of embedding the predefined component with such a physical target object. The process of embedding the predefined component may for example include embedding a preselected noise component with the target object, such as by applying the preselected noise component at a surface of the target object.

The surface may for example be machined to include the noise component. It should be understood that the noise component should be selected such that the device used for capturing the image data allows the noise component to be processed in accordance with the present disclosure. For example, a resolution of the image capturing device must be selected such that the image data of the target object allows the noise component to be identified.

It may however and in accordance with the present disclosure be desirable to select different schemes for embedding the embedding the predefined component with the physical target object based on the type of target object. As an example, a target object mainly comprising a fabric may need a different scheme for embedding the predefined component as compared to a target object mainly comprising metal.

When the target object is a physical target object, image data of the target object is captured/acquired and processed according to the scheme as defined by the present disclosure, for identifying the predefined component. Identification of the predefined component may then be used for e.g. validating an authenticity of the target object.

Preferably, validating the authenticity of the target object may additionally comprise determining if the identified predefined component has a defined relation to the target object. That is, if the target object for example is a watch and the identified predefined component is defined to relate to a shoe, then it may be determined that the identified predefined component is incorrect, and that the authenticity of the target object is compromised. The image data of the target object may as such be used for determining the type of the object, such as e.g. if the target object is a watch or a shoe. It may of course increase the granularity further, allowing the computer system to determine the type or brand of the watch, shoe, bag, etc. In some embodiments the processing unit is thus adapted to include a module for such a determination, where this module also may be implementing a machine-learning scheme that has been trained in relation to different types of objects. Other distinctive features of the target object may also be used in the process of determining the authenticity of the target object.

According to another aspect of the present disclosure, there is provided a computer system adapted to identify a predefined component embedded within image data of a target object, the computer system comprising a processing unit, wherein the processing unit is adapted to receive the image data, identify a noise component from the image data by applying a machine-learning based scheme to the image data, wherein the noise component is embedded with the target object, derive, based on identifiable features comprised with the noise component, the predefined component from the identified noise component, and identify the predefined component by comparison with prestored data in a memory element arranged in communication with the processing unit. This aspect of the present disclosure provides similar advantages as discussed above in relation to the previous aspects of the present disclosure.

Preferably, the computer system further comprises an object capturing device for capturing the image data of the target object. The object capturing device must however not just be limited to including an image capturing device (i.e. a camera). Rather, other types of object capturing devices are also possible, depending on the type of the target object and/or a structure of the predefined component. For example, in case a surface of the physical target object is embossed with the predefined component, it could for example be possible to make use of a Lidar, a radar, a laser scanner, etc. Other sensors systems, present and future, are of course possible and within the scope of the present disclosure. It may of course be possible to combine more than one sensor with the object capturing device, such for example an image capturing device and a Lidar.

In some embodiments it may be desirable to implement the machine-learning based scheme as a supervised machine-learning process. Due to the fact that the machine-learning process is supervised, it may be possible for e.g. an operator/user to “correct” decisions made by the machine-learning based scheme that is deemed by the operator/user to be incorrect. It should however be understood that it in contrast to the above also may be possible to implement the machine-learning based scheme as an unsupervised machine-learning process, allowing the implementation to be completely autonomous in the identifications and determinations. It may of course, and in line with the present disclosure, be possible to allow for a mixture of supervised and unsupervised involvement, for example depending on a state of implementation of the image processing scheme such as by allowing the machine-learning based scheme to initially be supervised and then later transitioning to be unsupervised or vice versa.

As indicated above, the database and the computer system may be arranged remotely from each other. The computer system may also in some embodiments be a so-called cloud-based computing system, where the processing unit forms part of a so-called cloud server. Thus, the computing power provided by means of the present disclosure may be distributed between a plurality of processing units or servers, and the location of the processing units/servers must not be explicitly defined. Advantageous following the use of a cloud-based solution is also the inherent redundancy achieved, and for the possibility of applying more complex machine-learning processes as compared to what may be possible using a single embedded processing unit.

It should however also be understood that the computer system could be provided as a component of an electronic user device. Such an electronic user device may for example be a mobile phone or similar. Accordingly, one or a plurality of object capturing devices of the mobile phone may thus be used for e.g. acquiring image data of a physical target object, and a processing unit comprised with the mobile phone may then be used for identifying the predefined component that has been embedded with the target object. Thus, the mobile phone may be used “on the fly” for watermarking purposes, i.e. to identify a watermark (i.e. the predefined component) that has been embedded with a target object. A user may as such take e.g. a photo of the target object and (essentially) instantaneous get back a confirmation of if the target object is a copy or an “original” object. The user may thus use the scheme according to the present disclosure to validate the target object, minimizing the risk of scammers providing unlawfully copied objects.

According to a further aspect of the present disclosure, there is provided a computer program product comprising a non-transitory computer readable medium having stored thereon computer program means for controlling a computer system adapted to identify a predefined component embedded within image data of a target object, the computer system comprising a processing unit, wherein the computer program product comprises code for receiving, at a processing unit, the image data, code for identifying, by the processing unit, a noise component from the image data by applying a machine-learning based scheme to the image data, wherein the noise component is embedded with the target object, code for deriving, by the processing unit and based on identifiable features comprised with the noise component, the predefined component from the identified noise component, and code for identifying, by the processing unit, the predefined component by comparison with prestored data in a memory element arranged in communication with the processing unit. Also this aspect of the present disclosure provides similar advantages as discussed above in relation to the previous aspects of the present disclosure.

A software executed by the processing unit for operation in accordance to the present disclosure may be stored on a computer readable medium, being any type of memory device, including one of a removable nonvolatile random access memory, a hard disk drive, a floppy disk, a CD-ROM, a DVD-ROM, a USB memory, an SD memory card, a solid state drive, other non-volatile flash based storage mediums, or a similar computer readable medium known in the art.

In summary, the present disclosure generally relates to a novel concept of identifying a predefined component embedded within image data of a target object, wherein the computer system comprises a processing unit and the method comprising the steps of receiving, at the processing unit, the image data, identifying, by the processing unit, a noise component from the image data by applying a machine-learning based scheme to the image data, deriving, by the processing unit, the predefined component from the identified noise component, and identifying, by the processing unit, the predefined component by comparison with prestored data in a memory element arranged in communication with the processing unit.

This in line with the present disclosure achieved by applying a machine-learning based scheme to for identifying the noise component from the image data representative of the target object, where the predefined component is derived from the identified noise component. The predefined component is then compared to other objects for determining an identity of the predefined component.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 conceptually illustrates a computer system according to a currently preferred embodiment of the present disclosure,

FIGS. 2A-2C presents different physical target objects comprising an embedded predefined component in line with the present disclosure,

FIG. 3 is a flow chart illustrating the steps of performing the method according to a currently preferred embodiment of the present disclosure, and

FIG. 4A and 4B schematically illustrates a possible implementation of a machine-learning based scheme used in conjunction with the present disclosure.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled person. Like reference characters refer to like elements throughout. The following examples illustrate the present disclosure and are not intended to limit the same.

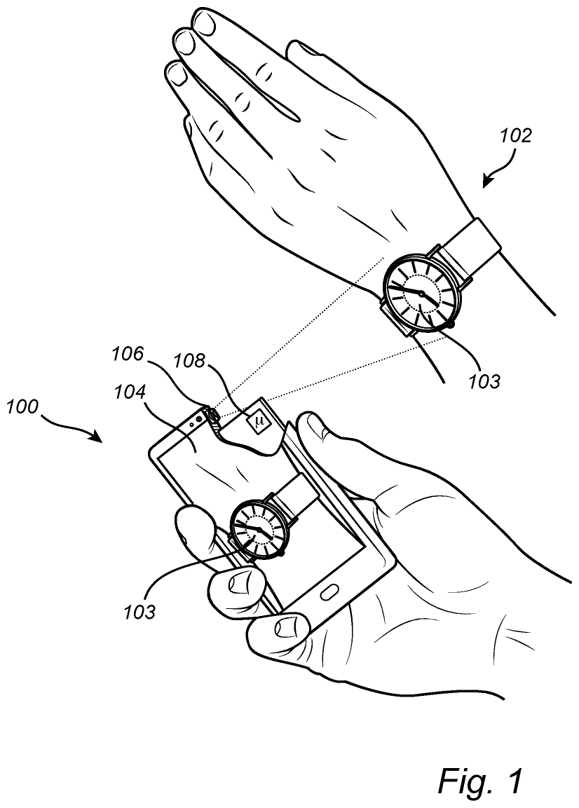

Turning now to the drawings and to FIG. 1 in particular, there is conceptually illustrated a computer system 100 adapted for identifying a predefined component embedded within image data of a target object 102. The computer system 100 is in FIG. 1 illustrated as a smart phone. It should furthermore be noted that the computer system as an alternative may be any other type of portable electronic device, such as a laptop, a tablet computer, or any other type of present or future similarly configured device. The target object 102 is in FIG. 1 shown as a watch, where the predefined component has been embedded within an area 103 of the watch 102, specifically at a face (or dial) of the watch 102.

The smart phone 100 comprises a display unit 104 with a touch screen interface, as well as at least one image capturing device (e.g. a camera) 106. Preferably and as is apparent for the skilled person, the smartphone 100 further comprises a first antenna for WLAN/Wi-Fi communication, a second antenna for telecommunication communication, a microphone, a speaker, and a phone control unit. Further hardware elements are of course possibly comprised with the mobile phone.

The smart phone 100 further comprises a processing unit 108, arranged in communication with the display unit 104 and the camera 106. For reference, the processing unit may for example be manifested as a general-purpose processor, a graphics processing unit, an application specific processor, a circuit containing processing components, a group of distributed processing components, a group of distributed computers configured for processing, a field programmable gate array (FPGA), etc. The processor may be or include any number of hardware components for conducting data, signal and/or image processing or for executing computer code stored in memory. It may also be possible and within the scope to make use of system-on-chip (SOC) implementations. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

As presented above, the present disclosure may in some embodiments make use of the smart phone 100 for assisting a user/operator in determining if the target object 102 is in fact a true original or an unlawful copy. In line with the present disclosure a true original is defined as a target object 102 comprising a correctly matching predefined component, i.e. where the predefined component is somewhat related to the target object 100. Such a relation may for example be determined by requesting, from e.g. a database, what type of target object 102 the predefined component has been embedded with.

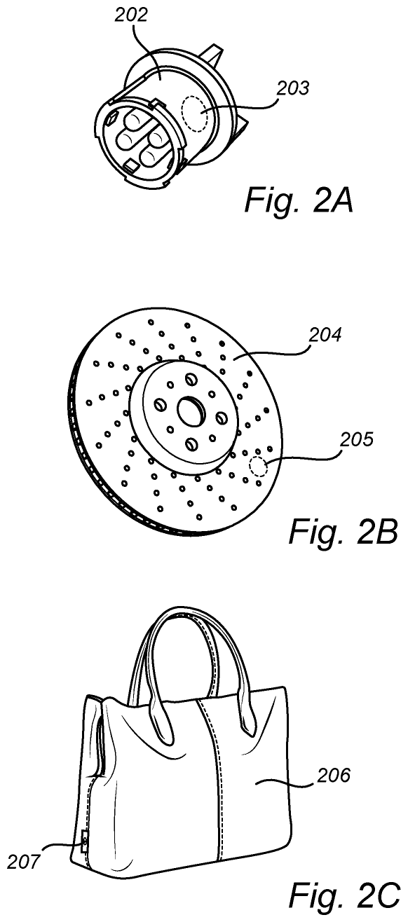

Turning now to FIGS. 2A-2C, illustrating three different target objects 202, 204 and 206 according to the present disclosure.

The target object 202 is in FIG. 2A an automotive electrical connector, where the predefined component has been embedded within an area 203 of the automotive electrical connector 202, specifically at in a plastic shell of the automotive electrical connector 202.

The target object 204 is in FIG. 2B a brake disc, where the predefined component has been embedded within an area 205 of the brake disc 204, specifically in a surface of the brake disc 204.

The target object 206 is in FIG. 2C a bag, where the predefined component has been embedded within an area 207 of the bag 206, specifically in a brand stamp attached to the bag 206.

Other target objects, physical as well as digital are of course possible and within the scope of the present disclosure.

In some embodiments a surface adjustment arrangement is used for embedding the noise component with the target objects 102, 202, 204, 206. Such a surface adjustment arrangement may for example include an engraver. In some embodiments the engraver may operate to engrave the noise component in a two-dimensional manner. However, the noise component could also, or instead, be embedded as a three-dimensional noise component in a surface of the target object.

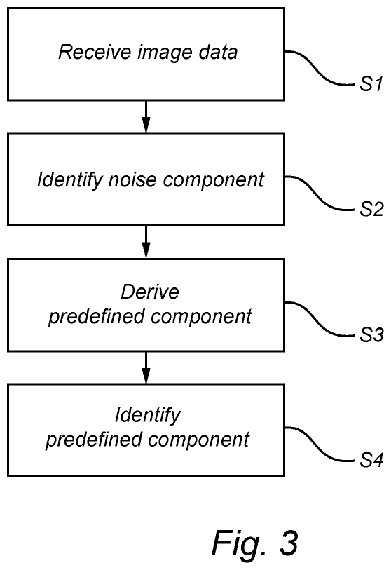

With further reference to FIG. 3, the computer system 100 (generally as well the smart phone 100) is, during operation adapted to perform a plurality of functions for identifying the predefined component.

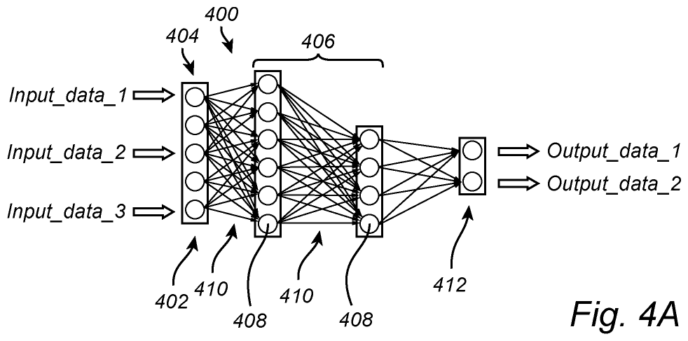

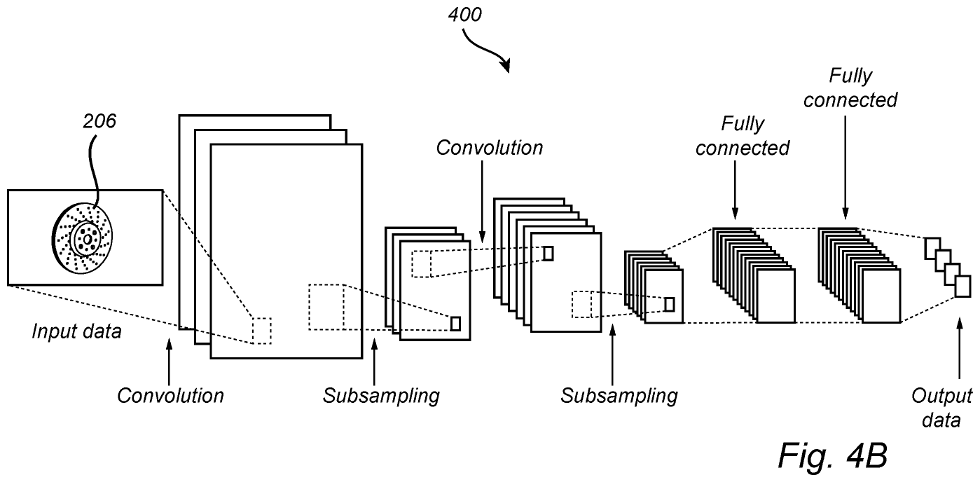

The steps performed by the computer system 100 comprises receiving, S1, at the processing unit 108, the image data. The image data may for example, with reference again to FIG. 1, be acquired using the camera 106. The processing unit 108 will then identify, S2, a noise component from the image data by applying a machine-learning based scheme to the image data. This process will be further elaborated in relation to FIGS. 4A and 4B.

Once the noise component has been identified from the image data, the processing unit will derive, S3, the predefined component from the noise component. As discussed above, deriving the predefined component from the noise component may be achieved by providing the noise component as an input to a feature extraction algorithm, where the feature extraction algorithm has been arranged to identify specific features comprised with the noise component.

The scheme according to the present disclosure then proceed to identify, S4 the predefined component by means of a comparison process. In the comparison process the predefined component that has been derived from the noise component will be compared with other prestored comparable components. The comparison process may for example include comparing the predefined component with a plurality of comparable components stored in a database. The processing unit 108 may for example be adapted to determine a level of matching between the predefined component and with each of the plurality of comparable components stored in a database. The best matching component in the database is then used for identifying the predefined component.

It may, as also discussed above, be possible to determine (from the image of the target object) a type of target object. The database storing the plurality of different comparable components may also include an identifier for the target object. It may thus be possible to compare the identifier of the target object with the actual target object (within the image). If there is a match, then the target object may be determined to be a true original.

Turning now to FIGS. 4A and 4B presenting presented schematic illustrations of a possible implementation of a machine-learning based scheme used in conjunction with the present disclosure. Specifically, and has been discussed above, the machine-learning based scheme is in accordance with the present disclosure used for identifying a noise component from the image data, as well as possibly for determining a type of the target object. The discussion below will be focusing on how to identify the noise component from the image data.

FIG. 4A illustrates a possible approach of implementing a deep neural network 400 adapted for identifying the noise component from the image data.

The block diagram comprises an input layer 402, configured to receive input data to the deep neural network. The input data includes mathematical representations of the image data and data relating to an expected structure of the noise component. It may also be possible to include information relating to the type of target object where the noise component has been embedded.

The image data, the data relating to the expected structure of the noise component and the data relating to the type of the target object may be provided as matrix of data, or as a graph. The image data may in some embodiments include a series of images illustrating the target object. The input layer includes nodes 404 associated with each of the inputs.

The deep neural network 400 may also include one or more convolutional layers in block 406. A deep neural network based on recurrent layers take current data from the input layer 402 as an input in addition to previously processed data. In other words, recurrent layers are advantageously used for capturing the history of the input data.

Nodes 404 of the input layer 402 communicate with the nodes 408 of the layers 406 via connections 410. The connections 410 and weights of the connections are determined during training sessions, e.g. supervised or unsupervised training.

The identified noise component is provided in the form of mathematical representations provided as an output in at output layer 412. It should be noted that the number of connections and nodes for each layer may vary, FIG. 4A is only provided as an example. Accordingly, in some deep neural network designs more than the indicated layers in FIG. 4A may be used.

In an exemplary embodiment of the present disclosure the machine-learning based scheme applies a convolutional neural network for at least portions of the object identification. In a convolutional neural network, as is known per se to the skilled person, convolutions of the input layer are used to compute the output. Local connections are formed such that each part of the input layer is connected to a node in the output. Each layer applies filters whereby the parameters of the filters are learned during training phases for the neural network.

The deep neural network may be trained based on supervised learning based on general noise component and their related target objects, where a supervisor (user) will assist in the training process. Alternatively, the deep neural network is trained by un-supervised learning based on similar information.

Furthermore, the control functionality of the present disclosure may be implemented using existing computer processors, or by a special purpose computer processor for an appropriate system, incorporated for this or another purpose, or by a hardwire system. Embodiments within the scope of the present disclosure include program products comprising machine-readable medium for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, solid state drives or other non-volatile flash based storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures may show a sequence, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art.

In addition, variations to the disclosed embodiments can be understood and effected by the skilled addressee in practicing the claimed present disclosure, from a study of the drawings, the disclosure, and the appended claims. Furthermore, in the claims, the word “comprising” does not exclude other elements or steps, and the indefinite article “a” or “an” does not exclude a plurality.

1. A method for identifying a predefined component embedded within image data of a target object using a computer system, wherein the computer system comprises a processing unit, the method comprising:
receiving, at the processing unit, the image data,
identifying, by the processing unit, a noise component from the image data by applying a machine-learning based scheme to the image data, wherein the noise component is embedded with the target object,
deriving, by the processing unit and based on identifiable features comprised with the noise component, the predefined component from the identified noise component, and
identifying, by the processing unit, the predefined component by comparison with prestored data in a memory element arranged in communication with the processing unit.

2. The method according to claim 1, wherein the machine-learning based scheme comprises a machine-learning pipeline.

3. The method according to claim 2, wherein the machine-learning pipeline comprises a plurality of autoencoder components.

4. The method according to claim 1, wherein the machine-learning based scheme is trained with a plurality of different image data each comprising a known noise component.

5. The method according to claim 1, wherein the memory element is a database populated with a plurality of different target objects.

6. The method according to claim 1, wherein the target object is selected from a group comprising an image and a physical product.

7. The method according to claim 1, further comprising:
embedding, by the processing unit, a preselected noise component with the target object.

8. The method according to claim 7, wherein a scheme for embedding the preselected noise component with the target object is selected based on a type of the target object.

9. The method according to claim 8, wherein, when the target object is a physical component the method further comprises:
applying the preselected noise component at a surface of the target object.

10. The method according to claim 8, wherein, when the target object is an image, the method further comprises:
combining an original image with the preselected noise component to form a noisy image.

11. A computer system adapted to identify a predefined component embedded within image data of a target object, the computer system comprising a processing unit, wherein the processing unit is adapted to:
receive the image data,
identify a noise component from the image data by applying a machine-learning based scheme to the image data, wherein the noise component is embedded with the target object,
derive, based on identifiable features comprised with the noise component, the predefined component from the identified noise component, and
identify the predefined component by comparison with prestored data in a memory element arranged in communication with the processing unit.

12. The computer system according to claim 11, further comprising an object capturing device for capturing the image data of the target object.

13. The computer system according to claim 11, further comprising the memory element, wherein the memory element is a database populated with a plurality of different target objects.

14. The computer system according to claim 11, wherein the machine-learning based scheme comprises a machine-learning pipeline.

15. The computer system according to claim 11, wherein the target object is a physical component, and the processing unit is further adapted to:
form control signals for manipulating a surface adjustment arrangement to apply a preselected noise component at a surface of the target object.

16. An electronic user device, comprising a computer system according to claim 11.

17. A computer program product comprising a non-transitory computer readable medium having stored thereon computer program means for controlling a computer system adapted to identify a predefined component embedded within image data of a target object, the computer system comprising a processing unit, wherein the computer program product comprises:
code for receiving, at a processing unit, the image data,
code for identifying, by the processing unit, a noise component from the image data by applying a machine-learning based scheme to the image data, wherein the noise component is embedded with the target object,
code for deriving, by the processing unit based on identifiable features comprised with the noise component, the predefined component from the identified noise component, and
code for identifying, by the processing unit, the predefined component by comparison with prestored data in a memory element arranged in communication with the processing unit.
